(19) United States
(12) Patent Application Publication
(10) Pub. No.: US 2017/0060612 A1
(43) Pub. Date: Mar. 2, 2017

(54) TERMINAL DEVICE, SYSTEM FOR CONTROLLING VIRTUAL MACHINE AND METHOD EMPLOYING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MING-CHIN HO, New Taipei (TW); CHIH-YUAN HUANG, New Taipei (TW)

(21) Appl. No.: 14/921,105

(22) Filed: Oct. 23, 2015

(30) Foreign Application Priority Data
Aug. 26, 2015 (TW) 104127933

(51) Int. Cl. G06F 9/455

(52) U.S. Cl. CPC G06F 9/45558; G06F 2009/45562; G06F 2009/4557; G06F 2009/45595

(57) ABSTRACT

A method for controlling a virtual machine, on a terminal device, the method includes receiving a request to create a virtual machine sent by a terminal device via an instant communication software and granting the terminal device an authority to create the virtual machine in response to the received request to create the virtual machine, receiving setting information of the virtual machine sent by the terminal device via the instant communication software when the server grants the terminal device the authority to create the virtual machine, and creating the virtual machine according to the received setting information of the virtual machine.

### CROSS-REFERENCE TO RELATED APPLICATIONS

This application claims priority to Taiwanese Patent Application No. 104127933 filed on Aug. 26, 2015, the contents of which are incorporated by reference herein.

### FIELD

The subject matter herein generally relates to communication field, especially relates to a terminal device, a system for controlling a virtual machine and a method employing the same.

### BACKGROUND

Nowadays, a dedicated management software, such as VMware, is used to manage a virtual machine by a manager of the network. However, the user of the virtual machine usually has no authority to manage the virtual machine via the management software.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a running environment of a system for controlling virtual machine.

FIG. 2 is a diagrammatic view of one embodiment of instant communication software interface.

FIG. 3 is a block diagram of one embodiment of system for controlling virtual machine.

FIG. 4 is a flowchart of one embodiment of a method for controlling virtual machine.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

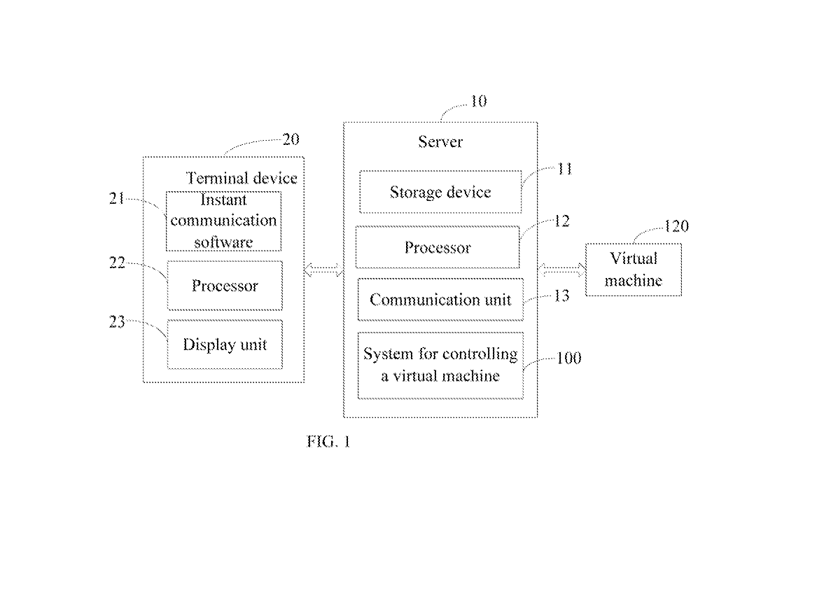

FIG. 1 illustrates a block diagram of one embodiment of a running environment of a system 100 for controlling a virtual machine 120. The system 100 runs on a server 10. The server 10 is able to communicate with at least one terminal device 20. In at least one embodiment, the server 10 communicates with the at least one terminal device 20 based on the Extensible Messaging Presence Protocol. In detail, the terminal device 20 installs an instant communication software 21 based on the XMPP. The terminal device 20 is able to communicate with the server 10 after opening the instant communication software 21. In at least one embodiment, the instant communication software 21 can be MSN(Microsoft Service Network) software.

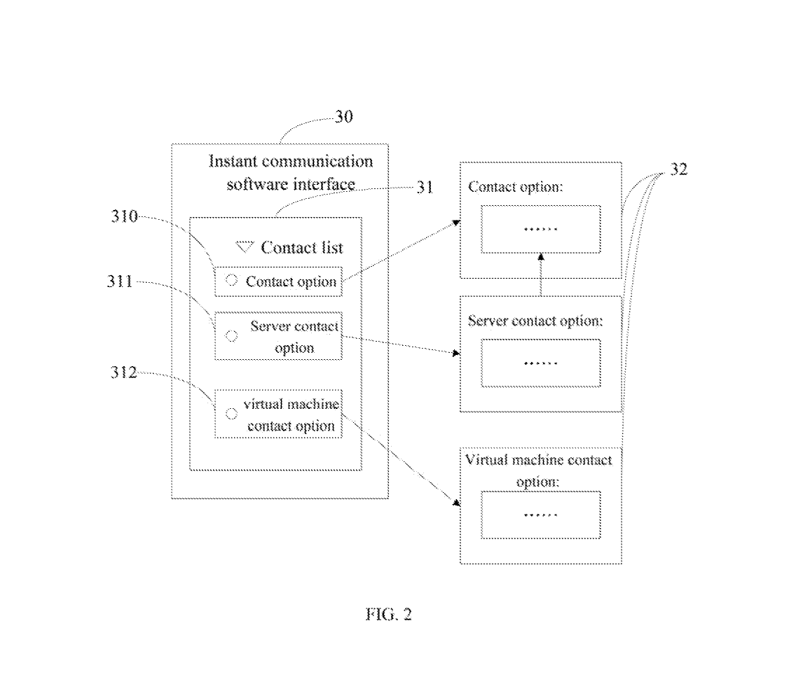

FIG. 2 illustrates a diagrammatic view of one embodiment of an instant communication software interface 30. In at least one embodiment, the terminal device 20 includes a display unit 23 and at least one processor 22. When opening the instant communication software 21 installed on the terminal device 20, the instant communication software interface 30 can be displayed on the display unit 23 of the processor 22. In at least one embodiment, the display unit 23 is a liquid crystal display. The instant communication software interface A includes a contact list 31. The contact list 31 includes a number of contact options 310. Each contact option 310 corresponds to a chat interface 32. The contact list 31 also includes a server contact option 311. The processor 22 can receive the information input on the chat interface 32 corresponding to the server contact option 311 by a user, and send the received information to the server 10. The processor 22 can receive information sent by the server 10 and display the received information on the chat interface 32 corresponding to the server contact option 311.

The server 10 includes a storage device 11, at least one processor12, and a communication unit 13. The system 100 is a collection of program instructions executed by the at least one processor 12. The server 10 can communicate with the terminal device 20 via the communication unit 13. In at least one embodiment, the terminal device 20 can be a smart phone, a tablet computer, a notebook computer or other suitable terminal device. The serve 10 can be a cloud serve. The communication unit 13 can be communication chips complying with the corresponding networks.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the system 100 for controlling the virtual machine 120.

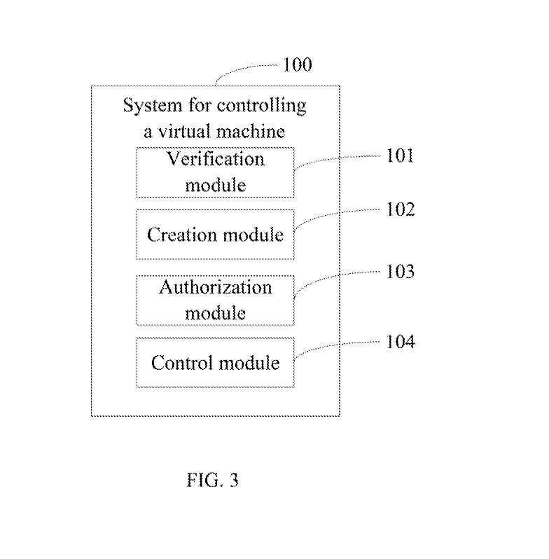

FIG. 3 illustrates in at least one embodiment, the system 100 can include a verification module 101, a creation module 102, an authorization module 103, and a control module 104. The modules 101-104 of the system 100 can be collections of software instructions stored in the storage device 11 of the serve 10 and executed by the processor 12 of the serve 10. The modules 101-104 of the system 100 also can include functionality represented as hardware or integrated circuits, or as software and hardware combinations, such as a special-purpose processor or a general-purpose processor with special-purpose firmware.

The verification module 101 is used to receive a request to create the virtual machine 120. The verification module 101 receives a verification code sent by the terminal device 20 in response to the received request to create the virtual machine 120, compares the received verification code with a target verification code, and grants the terminal device 20 an authority to create the virtual machine 120 when the verification module 101 determines the verification code matches with the target verification code.

In at least one embodiment, the target verification code is a dynamic password provided by the server 10. In detail, the user can input the request to create the virtual machine 120 via the chat interface 32 corresponding to the server contact option 311 of the instant communication software interface 30 displayed on the terminal device 20. The processor 22 of the terminal device 20 receives the request to create the virtual machine 120 and sends the request to the server 10. The verification module 101 receives the request to create the virtual machine 120 sent by the terminal device 20 via the communication unit 13. The verification module 101 sends a prompt message to prompt the user to input contact information, such as phone number or electronic mail via the communication unit 13 in response to the received request to create the virtual machine 120. When the processor 22 of the terminal device 20 receives the prompt message, the processor 22 displays the prompt message on the chat interface 32 corresponding to the server contact option 311 to show the user. The processor 22 also receives the contact information input by the user on the chat interface 32 and sends the received contact information to the server 10. The verification module 101 randomly generates and stores a dynamic password, and sends the generated dynamic information to the user according to the received contact information when receiving the contact information sent by the terminal device 20. The user inputs the received dynamic password via the chat interface 32 corresponding to the server contact option 311 provided by the terminal device 20. The processor 22 of the terminal device 20 receives the dynamic password input by the user and sends the received dynamic password to the server 10. The verification module 101 receives the dynamic password sent by the terminal device 20 and compares the received dynamic password with the stored dynamic password. The verification module 101 grants the terminal device 20 the authority to create the virtual machine 120 when determining the received dynamic password matches with the stored dynamic password.

In at least one embodiment, the target verification code is a default verification code set by the user in advance. In detail, the user can input the request to create the virtual machine 120 via the chat interface 32 corresponding to the server contact option 311 of the instant communication software interface 30 displayed on the terminal device 20. The processor 22 of the terminal device 20 receives the request to create the virtual machine 120 and sends the request to the server 10. The verification module 101 receives the request to create the virtual machine 120 sent by the terminal device 20 via the communication unit 13. The verification module 101 directly sends a prompt message to prompt the user to input verification code via the communication unit 13 in response to the received request to create the virtual machine 120. The user inputs the verification code via the chat interface 32 corresponding to the server contact option 311 provided by the terminal device 20. The processor 22 of the terminal device 20 receives the verification code input by the user and sends the received verification code to the server 10. The verification module 101 receives the verification code sent by the terminal device 20 and compares the received verification code with the default verification code. The verification module 101 grants the terminal device 20 the authority to create the virtual machine 120 when determining the received verification code matches with the default verification code.

In at least one embodiment, the verification module 101 receives the request to create the virtual machine 120 sent by the terminal device 20 and directly grants the terminal device 20 the authority to create the virtual machine 120 without the password verification in response to the request to create the virtual machine 120.

The creation module 102 is used to receive setting information of the virtual machine 120 sent by the terminal device 20 when the verification module 101 grants the terminal device 20 the authority to create the virtual machine, and create the virtual machine 120 according to the received setting information of the virtual machine 120. In at least one t embodiment, the processor 22 of the terminal device 20 receives the setting information of the virtual machine 120 via the chat interface 32 corresponding to the server contact option 311, and sends the received setting information of the virtual machine 120 to the server 10. The creation module 102 creates the virtual machine 120 in the server 10 when the creation module 102 receives the setting information of the virtual machine 120. Therein, the setting information of the virtual machine 120 includes CPU type, memory, and hard disk. For example, when the user inputs information of setting the CPU type of the virtual machine 120 as dual core CPU, setting the memory of the virtual machine 120 as 1 GB, and setting the hard disk of the virtual machine 120 as 40 GB via the chat interface 32, the processor 22 of the terminal device 20 receives the setting information of the virtual machine 120 and sends the setting information of the virtual machine 120 to the server 10. The creation module 102 receives the setting information of the virtual machine 120 sent by the terminal device 20 via the communication unit 13, and creates the virtual machine 120 with dual core CPU, 1 GB memory, 40 GB hard disk.

The authorization module 103 is used to receive a request to control the virtual machine 120, and grant the terminal device 20 an authority to send a control command to control the virtual machine 120 in response to the request to control the virtual machine 120. FIG. 2 illustrates in at least one embodiment, the user can input the request to control the virtual machine 120 via the chat interface 32 corresponding to the server contact option 311. The processor 22 of the terminal device 20 receives the request to control the virtual machine 120 and sends the request to the server 10. The authorization module 103 receives the request to control the virtual machine 120 via the communication unit 13, and grants the terminal device 20 the authority to send the control command to control the virtual machine 120 in response to the request, and sends an instruction of adding virtual machine contact option 312 corresponding to the virtual machine 120 in the contact list 31 to the terminal device 20. The processor 22 of the terminal device 20 receives the instruction sent by the server 10, and adds the virtual machine contact option 312 corresponding to the virtual machine 120 in the contact list 31. Therein, the virtual machine contact option 312 corresponds a chat interface 32. In at least one embodiment, the control command includes, but not limited to, open command, pause command, restore command, stop command, and query command.

The control module 104 is used to receive the control command to control the virtual machine 120 sent by the terminal device 20, and control the virtual machine 120 according to the received control command. FIG. 2 illustrates in at least one embodiment, the processor 22 of the terminal device 20 receives the control command to control the virtual machine 120 via the chat interface 32 corresponding to the virtual machine contact option 312, and sends the control command to server 10. The control module 104 receives the control command via the communication unit 13, and controls the virtual machine 120 according to the control command.

In at least one embodiment, the processor 22 of the terminal device 20 receives the open command via the chat interface 32 corresponding to the virtual machine contact option 312, and sends the open command to the server 10. The control module 104 receives the open command via the communication unit 13, and opens the virtual machine 120 according to the received open command.

In at least one embodiment, the processor 22 of the terminal device 20 receives the stop command via the chat interface 32 corresponding to the virtual machine contact option 312, and sends the stop command to the server 10. The control module 104 receives the stop command via the communication unit 13, and stops the virtual machine 120 according to the received stop command.

In at least one embodiment, the processor 22 of the terminal device 20 receives the pause command via the chat interface 32 corresponding to the virtual machine contact option 312, and sends the pause command to the server 10. The control module 104 receives the pause command via the communication unit 13, and pauses the virtual machine 120 according to the received pause command.

In at least one embodiment, the processor 22 of the terminal device 20 receives the restore command via the chat interface 32 corresponding to the virtual machine contact option 312, and sends the restore command to the server 10. The control module 104 receives the restore command via the communication unit 13, and restores the virtual machine 120 according to the received restore command after the control module 104 pauses the virtual machine 120 according to the received pause command

In at least one embodiment, the processor 22 of the terminal device 20 receives the query command via the chat interface 32 corresponding to the virtual machine contact option 312, and sends the query command to the server 10. The control module 104 receives the query command via the communication unit 13, acquires the status information of the virtual machine 120, and sends the acquired status information of the virtual machine 120 to the terminal device 20 via the communication unit 13. Therein, the status information of virtual machine 120 acquired by the control module 104 includes, but not limited to, operation system type, IP address, CPU utilization, memory utilization, and hard disk utilization.

In at least one embodiment, the processor 22 of the terminal device 20 is also used to detect whether the virtual machine contact option 312 of the instant communication software interface 30 is deleted, and sends a control command of deleting the virtual machine 120 to the server 10 when the processor 22 of the terminal device 20 detects the virtual machine contact option 312 of the instant communication software interface 30 is deleted. The control module 104 receives the control command of deleting the virtual machine 120 sent by the terminal device 20, and deletes the virtual machine 120 according to the received control command of deleting the virtual machine 120.

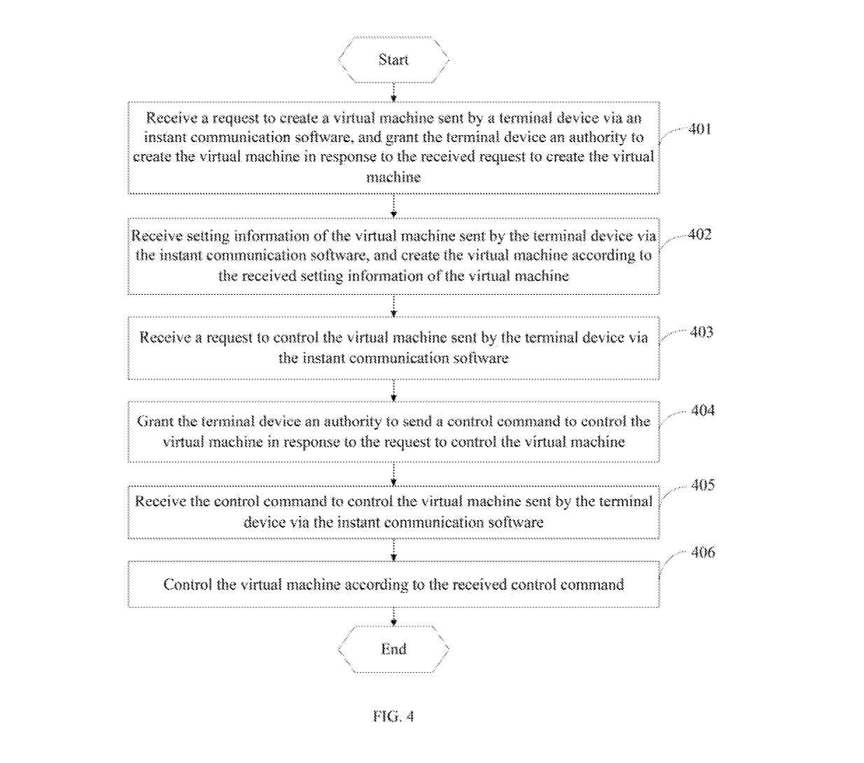

FIG. 4 illustrates a flowchart of one embodiment of a method for controlling the virtual machine 120. The method is provided by way of example, as there are a variety of ways to carry out the method. The method described below can be carried out using the configurations illustrated in FIG. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, a verification module receives a request to create a virtual machine sent by a terminal device via an instant communication software, grants the terminal device an authority to create the virtual machine in response to the received request to create the virtual machine.

In at least one embodiment, when receiving the request to create a virtual machine sent by the terminal device, the verification module further receives a verification code sent by the terminal device in response to the received request, compares the received verification code with a target verification code, and grants the terminal device an authority to create the virtual machine when the verification module determines the received verification code matches with target verification code. In at least one embodiment, the target verification code is a dynamic password provided by the server 10. A user can input the request to create the virtual machine via a chat interface corresponding to a server contact option of an instant communication software interface displayed on the terminal device. A processor of the terminal device receives the request to create the virtual machine and sends the request to the server. The verification module receives the request to create the virtual machine sent by the terminal device via a communication unit. The verification module sends a prompt message to prompt the user to input contact information, such as phone number or electronic mail via the communication unit in response to the received request to create the virtual machine. When the processor of the terminal device receives the prompt message, the processor of the terminal device displays the prompt message on the chat interface corresponding to the server contact option. The processor of the terminal device also receives the contact information input by the user on the chat interface and sends the received contact information to the server. The verification module randomly generates and stores a dynamic password, and sends the generated dynamic information to the user according to the received contact information when receiving the contact information sent by the terminal device. The user inputs the received dynamic password via the chat interface corresponding to the server contact option provided by the terminal device. The processor of the terminal device receives the dynamic password input by the user and sends the received dynamic password to the server. The verification module receives the dynamic password sent by the terminal device and compares the received dynamic password with the stored dynamic password. The verification module grants the terminal device the authority to create the virtual machine when determining the received dynamic password matches with the stored dynamic password.

In at least one embodiment, the target verification code is a default verification code set by the user in advance. In detail, the user can input the request to create the virtual machine via the chat interface corresponding to the server contact option of the instant communication software interface displayed on the terminal device. The processor of the terminal device receives the request to create the virtual machine and sends the request to the server. The verification module receives the request to create the virtual machine sent by the terminal device via the communication unit. The verification module sends a prompt message to prompt the user to input verification code via the communication unit in response to the received request to create the virtual machine. The user inputs the verification code via the chat interface corresponding to the server contact option provided by the terminal device. The processor of the terminal device receives the verification code input by the user and sends the received verification code to the server. The verification module receives the verification code sent by the terminal device and compares the received verification code with the default verification code. The verification module grants the terminal device the authority to create the virtual machine when determining the received verification code matches with the default verification code.

At block 402, a creation module receives setting information of the virtual machine sent by the terminal device via the instant communication software, creates the virtual machine according to the received setting information of the virtual machine. In at least one embodiment, the processor of the terminal device receives the setting information of the virtual machine via the chat interface corresponding to the server contact option, and sends the received setting information of the virtual machine to the server. The creation module creates the virtual machine in the server when receiving the setting information of the virtual machine. Therein, the setting information of the virtual machine includes CPU type, memory, and hard disk.

At block 403, an authorization module receives a request to control the virtual machine.

At block 404, the authorization module grants the terminal device an authority to send a control command to control the virtual machine in response to the request to control the virtual machine. FIG. 2 illustrates in at least one embodiment, the user can input the request to control the virtual machine via the chat interface corresponding to the server contact option of the instant communication software interface. The processor of the terminal device receives the request to control the virtual machine and sends the request to the server. The authorization module receives the request to control the virtual machine via the communication unit, and grants the terminal device the authority to send the control command to control the virtual machine in response to the request, and sends an instruction of adding virtual machine contact option corresponding to the virtual machine in a contact list to the terminal device. The processor of the terminal device receives the instruction sent by the server, and adds the virtual machine contact option corresponding to the virtual machine in the contact list. Therein, the virtual machine contact option corresponds a chat interface. In at least one embodiment, the control command includes, but not limited to, open command, pause command, restore command, stop command, and query command

At block 405, a control module receives the control command to control the virtual machine sent by the terminal device.

At block 406, the control module controls the virtual machine according to the received control command. FIG. 2 illustrates in at least one embodiment, the processor of the terminal device receives the control command to control the virtual machine via the chat interface corresponding to the virtual machine contact option, and sends the control command to server. The control module receives the control command via the communication unit, and controls the virtual machine according to the control command

In at least one embodiment, the method further includes: the control module receives the control command of deleting the virtual machine, and deletes the virtual machine according to the received control command

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A terminal device, having an instant communication software, the instant communication software comprises an instant communication software interface and allows the terminal device can communicate with a server, illustrated thereon the terminal device comprises:
a display unit configured to display the instant communication software interface comprising a contact list comprising a server contact option corresponding to a first chat interface; and
at least one processor coupled to the display unit and configured to execute instructions to cause the terminal device to:
receive a request to create a virtual machine via the first chat interface corresponding to the server contact option;
send the request to create the virtual machine to the server;
receive setting information of the virtual machine via the first chat interface corresponding to the server contact option; and
send the received setting information of the virtual machine to the server.

2. The terminal device according to claim 1, wherein the processor is further configured to:
when receiving an instruction of adding virtual machine contact option corresponding to the virtual machine in the contact list sent by the server, add the virtual machine contact option in the contact list, wherein, the virtual machine contact option corresponds to a second chat interface.

3. The terminal device according to claim 2, wherein the processor is further configured to execute instructions to cause the terminal device to:
receive a control command to control the virtual machine via the second chat interface corresponding to the virtual machine contact option, and send the control command to server.

4. The terminal device according to claim 3, wherein the control command comprises an open command, a pause command, a restore command, a stop command, and a query command.

5. The terminal device according to claim 3, wherein the processor is further configured to execute instructions to cause the terminal device to:
detect whether the virtual machine contact option is deleted, and send a control command of deleting the virtual machine to the server when detecting the virtual machine contact option is deleted.

6. The terminal device according to claim 1, wherein the setting information of the virtual machine comprises CPU type, memory, and hard disk.

7. A system for controlling a virtual machine on a server, the system comprises:
at least one processor; and
a plurality of modules which are collections of instructions executable by the processor, the plurality of modules comprising:
a verification module configured to, upon execution by the at least one processor, cause the at least one processor to receive a request to create the virtual machine sent by a terminal device via an instant communication software and grant the terminal device an authority to create the virtual machine in response to the received request to create the virtual machine; and
a creation module configured to, upon execution by the at least one processor, cause the at least one processor to receive setting information of the virtual machine sent by the terminal device via the instant communication software when the verification module grants the terminal device the authority to create the virtual machine, and create the virtual machine according to the received setting information of the virtual machine.

8. The system according to claim 7, wherein the plurality of modules further comprise:
an authorization module configured to, upon execution by the at least one processor, cause the at least one processor to receive a request to control the virtual machine sent by the terminal device via the instant communication software, and grant the terminal device an authority to send a control command to control the virtual machine in response to the request to control the virtual machine; and
a control module configured to, upon execution by the at least one processor, cause the at least one processor to receive the control command to control the virtual machine sent by the terminal device via the instant communication software, and control the virtual machine according to the received control command.

9. The system according to claim 8, wherein the instant communication software comprises an instant communication software interface, the instant communication software interface comprises a contact list, the authorization module is further configured to, upon execution by the at least one processor, cause the at least one processor to send an instruction of adding a virtual machine contact option corresponding to the virtual machine in the contact list to the terminal device.

10. The system according to claim 8, wherein the control module is further configured to, upon execution by the at least one processor, cause the at least one processor to receive a control command of deleting the virtual machine sent by the terminal device, and delete the virtual machine according to the received control command of deleting the virtual machine.

11. The system according to claim 7, wherein the verification module is further configured to, upon execution by the at least one processor, cause the at least one processor to receive a verification code sent by the terminal device via the instant communication software, compare the received verification code with a target verification code, and grant the terminal device the authority to create the virtual machine when determining the verification code matches with the target verification code.

12. The system according to claim 11, wherein the verification code is a dynamic password or a default verification code set in advance.

13. A method for controlling a virtual machine, on a terminal device, the method comprises:
receiving a request to create a virtual machine sent by a terminal device via an instant communication software and granting the terminal device an authority to create the virtual machine in response to the received request to create the virtual machine; and
receiving setting information of the virtual machine sent by the terminal device via the instant communication software when the server grants the terminal device the authority to create the virtual machine, and creating the virtual machine according to the received setting information of the virtual machine.

14. The method according to claim 13, wherein the method further comprises:
receiving a request to control the virtual machine sent by the terminal device via the instant communication software, and granting the terminal device an authority to send a control command to control the virtual machine in response to the request to control the virtual machine; and
receiving the control command to control the virtual machine sent by the terminal device via the instant communication software, and controlling the virtual machine according to the received control command.

15. The method according to claim 14, wherein the instant communication software comprises an instant communication software interface, the instant communication software interface comprises a contact list, the method further comprises:
sending an instruction of adding a virtual machine contact option corresponding to the virtual machine in the contact list to the terminal device.

16. The method according to claim 14, wherein the method further comprises:
receiving a control command of deleting the virtual machine sent by the terminal device, and deleting the virtual machine according to the received control command of deleting the virtual machine.

17. The method according to claim 13, wherein the step of “receiving a request to create a virtual machine sent by a terminal device via an instant communication software and granting the terminal device an authority to create the virtual machine in response to the received request to create the virtual machine” further comprises:
receiving a verification code sent by the terminal device via the instant communication software, comparing the received verification code with a target verification code, and granting the terminal device the authority to create the virtual machine when determining the verification code matches with the target verification code.

18. The method according to claim 17, wherein the verification code is a dynamic password or a default verification code set in advance.
